(19) United States
(12) Patent Application Publication
(10) Pub. No.: US 2011/0281033 A1
(43) Pub. Date: Nov. 17, 2011

(54) COATING METHOD

(75) Inventors: YUN-LUNG CHEN, Tu-Cheng (TW); ZHONG-JIE LIU, Shenzhen City (CN); CUI XU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 12/952,533

(22) Filed: Nov. 23, 2010

(30) Foreign Application Priority Data
May 11, 2010 (CN) 201010168739.5

(51) Int. Cl. B05D 1/32

(52) U.S. Cl. 427/282

(57) ABSTRACT

A coating method for coating an enclosure is disclosed. A masking material and a coating material are applied to a flange of the enclosure. The masking material does not absorb the coating material.

### BACKGROUND

1. Technical Field

The present disclosure relates to a method for coating an electronic device enclosure, particularly, to a method for coating an enclosure with at least three connected shell portions that need to be coated.

2. Description of Related Art

Surfaces of computer enclosures, such as laptop or notebook computer enclosures, should be treated to improve surface properties of the enclosure, such as enhancing appearance, corrosion resistance, and scratch resistance. Typically, in a coating process, a number of adhesive strips are used to mask portions of the enclosure that should not be painted such as those portions used for grounding parts of the enclosure etc. However, the adhesive strips are costly and time consuming to apply and remove.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a view of an electronic device enclosure in accordance with an embodiment.

FIG. 2 is a diagram of a coating method for the electronic device enclosure in accordance with an embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

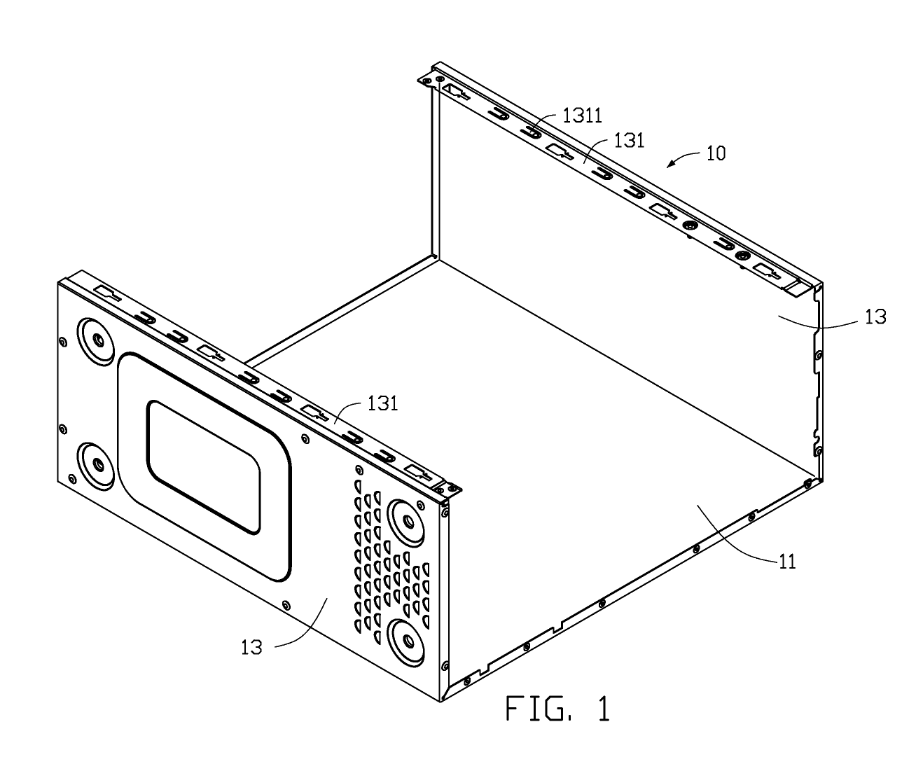

Referring to FIG. 1, a method for electrophoretically coating a surface in accordance with an embodiment can be used to coat an electronic device enclosure 10. In one embodiment, the electronic device enclosure 10 can be an enclosure of a computer, alarm system, or any other device enclosure to be coated that requires masking.

The electronic device enclosure 10 includes a bottom plate 11, and two side plates 13 connected to opposite edges of the bottom plate 11. In one embodiment, the two side plates 13 are substantially parallel to each other, and substantially perpendicular to the bottom plate 11. A flange 131 is connected to one top edge of each side plate 13. In one embodiment, the flanges 131 are substantially perpendicular to the side plates 13. A number of elastic pieces 1311 are formed on each flange 131, configured to make grounding connections to other panels not shown.

In this embodiment, the flanges 131 need to be masked. The masking material has antistatic quality, and is applied as a liquid but may harden to a solid at room temperature. In one embodiment, the masking material is a wax emulsion that vaporizes when heated to a temperature range of 160-220 degrees centigrade.

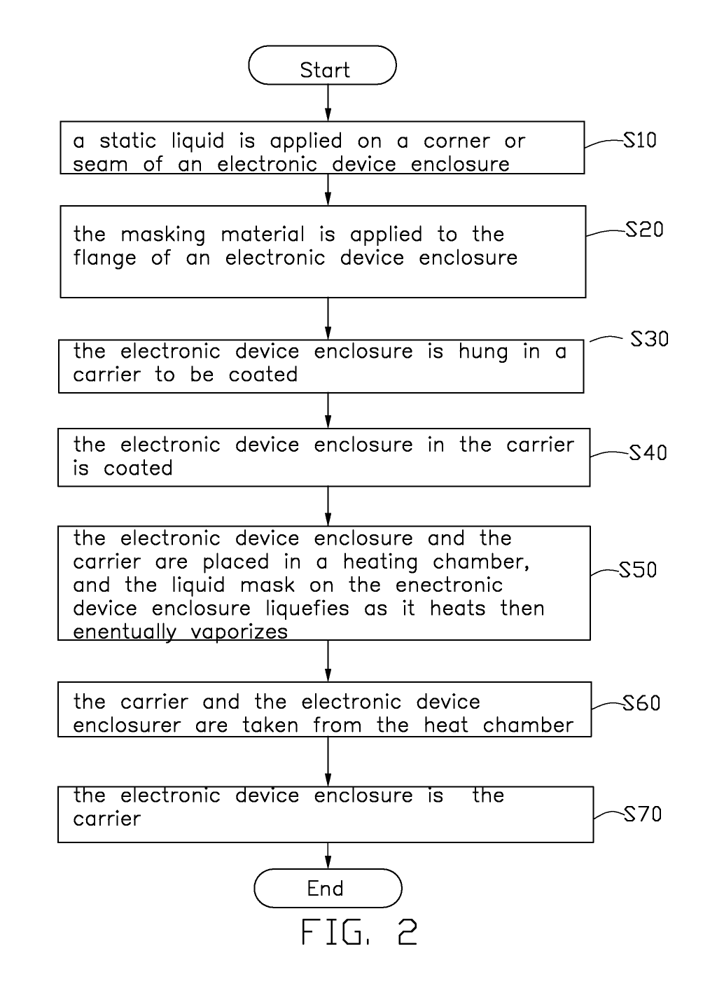

Referring to FIG. 2, a process of coating a surface in accordance with an embodiment for coating the electronic device enclosure 10, includes the following steps:

Step 10: Prior to the coating process, a static liquid may be applied to any hard to reach places, but not the flanges 131, that is, places where the coating material may not easily reach such as corners and seams. So the corner and seams can absorb the coating material, to make the electronic device enclosure 10 absorb the coating material effectively except the flange 131. The static liquid is a material with a low surface tension allowing it to more easily penetrate the hard to reach places. The static liquid in this embodiment is able to absorb the coating material.

Step 20: The masking material is applied to the flanges 131 and any other portions needing to be masked.

Step 30: the electronic device enclosure 10 is hung in a carrier (not shown) to be coated.

Step 40: the electronic device enclosure 10 is coated with the coating material.

Step 50: the electronic device enclosure 10 and the carrier are placed in a heating chamber (not shown). In one embodiment, the temperature in the chamber is in the range of 160-220 degrees centigrade. In this process, the liquid masking material of the flange 131 of the electronic device enclosure 10 liquefies as it heats then eventually vaporizes.

Step 60: after all masking material has vaporized, the electronic device enclosure 10 and the carrier are taken out from the chamber. In one embodiment, 15 minutes is sufficient time for complete vaporization of the masking material.

Step 70: the electronic device enclosure 10 is taken from the carrier, and the process ends.

With the present coating process the need for costly time consuming tape is eliminated and important parts of the electronic device enclosure 10 that need to be protected from coating are protected precisely and efficiently.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. A coating method for coating an enclosure, comprising the steps as follows:
applying a masking material to a flange of the enclosure;
hanging the enclosure in a carrier; and
coating the enclosure with a coating material, wherein the masking material absorbs no coating material.

2. The coating method of claim 1, further comprising administering a static liquid on a portion of the electronic device enclosure, before applying a masking material to the a flange of the enclosure.

3. The coating method of claim 1, further comprising placing the enclosure and the carrier in a heating member, and vaporizing the masking material applied on the flange of the enclosure, after coating the electronic device enclosure with a coating material.

4. The coating method of claim 3, wherein the masking material has antistatic quality, and is applied as a liquid but harden to a solid at room temperature.

5. The coating method of claim 4, the vaporizing the masking material is done at a temperature greater than 160 degrees centigrade.

6. The coating method of claim 4, the vaporizing the masking material is done at a temperature between 160 degrees centigrade and 220 degrees centigrade.

7. The coating method of claim 1, wherein the masking material is wax emulsion.

8. A coating method for coating an enclosure, the enclosure comprising a bottom plate and two side plates connected to the bottom plate, a flange located on each side plate, and the method comprising the steps as follows:
applying a masking material to a flange;
hanging the enclosure in a carrier; and
coating the enclosure with a coating material; wherein the masking material absorbs no coating material.

9. The coating method of claim 8, further comprising administering a static liquid on a portion of the enclosure, before applying a masking material to the enclosure.

10. The coating method of claim 8, further comprising placing the enclosure and the carrier in a heating chamber and vaporizing the masking material, after coating the electronic device enclosure with a coating material.

11. The coating method of claim 10, wherein the masking material has antistatic quality, and is applied as a liquid but harden to a solid at room temperature.

12. The coating method of claim 11, the vaporizing the masking material is done at a temperature greater than 160 degrees centigrade.

13. The coating method of claim 12, the vaporizing the masking material is done at a temperature between 160 degrees centigrade and 220 degrees centigrade.

14. The coating method of claim 8, wherein the masking material is wax emulsion.
